(19) United States
(12) Patent Application Publication
(10) Pub. No.: US 2020/0044438 A1
(43) Pub. Date: Feb. 6, 2020

(54) DC SOFT TURN-OFF MODULE

(71) Applicants: Shuguang He, Shenzhen (CN); Kinsang Hui, Hongkong (CN)

(72) Inventors: Shuguang He, Shenzhen (CN); Kinsang Hui, Hongkong (CN)

(21) Appl. No.: 16/055,132

(22) Filed: Aug. 5, 2018

(51) Int. Cl. H02H 9/00; H02H 9/02; H01C 7/12

(52) U.S. Cl. CPC H02H 9/001; H01C 7/12; H02H 9/026

(57) ABSTRACT

A DC soft turn-off module includes a switch contact and a soft turn-off circuit connected in parallel onto the switch contact. The soft turn-off circuit includes three branches connected each other in parallel. The first branch includes a thermistor and a first thyristor connected in series. The second branch comprises a capacitor and a first resistor connected in series. A second thyristor, a second resistor and a third resistor form a trigger branch for the first thyristor. The third branch includes a varistor connected in parallel onto the first branch and the second branch.

### BACKGROUND OF THE INVENTION

### Field of the Invention

The present invention relates to circuit breakers and more particularly to a direct current soft turn-off module for a switch of a HVDC electric system, which may softly turn off a current so as to eliminate an arc therein.

### Background

Circuit breakers for use in electrical circuits are well known. A high voltage direct current (HVDC) electric system has a number of capacitance or inductance devices, such as reactors and filters and so on, and as well has distributed parameter inductors and capacitors arranged on the transmission line. When a high current direct current (DC) circuit is to be cut-off, these devices may produce a great amount of energy in the form of electric arc. Although the switch contact is made from a metal material having a high melting point, the switch may also be burned or damaged by the heat, unless some measures are undertaken. Different from an alternating current having a zero-crossing where an arc automatically disappears, in a DC circuit, an arc is much more difficult to eliminate.

Conventionally, there are two methods to cut off a high current DC circuit. The first method is energy consumption by absorbing the energy produced from the cutting-off of the high current DC circuit in a short duration, by means of an arrangement such as an arc chute which may elongating the arc; or a plurality of contacts connected in series, each incorporating a resistor, and each opened once in a time by turns; or a varistor connected in parallel to the contact of the switch. The other method is the use of forced zero-crossing. By arranging capacitance and inductance devices in series, in parallel to the switch contact, the self-oscillation is produced when cutting off high current, so as to manually produce zero-crossings to extinguish the arc.

Although these above methods have been utilized in the prior arts to produce a wide variety of HDVC breakers, the complex structure and its high expense are their disadvantages. Some of them are difficult to manufacture, some are difficult to operate. In those cases, improvement needs to be made.

### SUMMARY OF THE INVENTION

A DC soft turn-off module for switching a HVDC electric system includes a switch contact and a soft turn-off circuit connected in parallel onto the switch contact. The soft turn-off circuit comprises a first branch and a second branch connected in parallel. The first branch comprises a thermistor and a first thyristor connected in series. One end of the thermistor connects to a first terminal of the switch contact, the other end of the thermistor connects to an anode of the first thyristor, and a cathode of the first thyristor connects to a second terminal of the switch contact. The thermistor is a PTC device having a positive temperature coefficient, and the holding current Ih of the first thyristor is greater than 10 mA.

The second branch includes a capacitor and a first resistor connected in series and then connected in parallel onto the switch contact. One end of the capacitor connects to the first terminal of the switch contact, the other end of the capacitor connects to one end of the first resistor, and the other end of the first resistor connects to the second terminal of the switch contact. A second thyristor, a second resistor and a third resistor form a trigger branch for the first thyristor. An anode of the second thyristor connects to a series connection between the capacitor and the first resistor, a control gate of the second thyristor and the third resistor in series connects to the series connection, a cathode of the second thyristor connects to one end of the second resistor, and the other end of the second resistor connects to the second terminal of the switch contact, and a series connection between the cathode of the second thyristor and the second resistor connects to a control gate of the first thyristor.

According to another exemplary embodiment of the invention, the soft turn-off circuit further includes a third branch including a varistor connected in parallel onto the first branch and the second branch. One end of the varistor connects to the first terminal of the switch contact, and the other end of the varistor connects to the second terminal of the switch contact.

According to another exemplary embodiment of the invention, a DC soft turn-off module includes a switch contact and a soft turn-off circuit connected in parallel onto the switch contact. The soft turn-off circuit includes a first branch and a second branch connected each other in parallel. The first branch includes a thermistor and a temperature-controlled switch connected in series. One end of the thermistor connects to a first terminal of the switch contact, the other end of the thermistor connects to one end of the temperature-controlled switch, and the other end of the temperature-controlled switch connects a second terminal of the switch contact.

The second branch includes a capacitor and a resistor connected in series and then connected in parallel onto the switch contact. One end of the capacitor connects to the first terminal of the switch contact, the other end of the capacitor connects to one end of the resistor, and the other end of the resistor connects to the second terminal of the switch contact.

According to another exemplary embodiment of the invention, the soft turn-off circuit further includes a third branch including a varistor connected in parallel onto the first branch and the second branch.

According to another exemplary embodiment of the invention, a DC soft turn-off module includes a switch contact and a plurality of soft turn-off circuits connected in series and then connected in parallel onto the switch contact. Each soft turn-off circuit includes the two or three branches connected in parallel to each other as described in the above exemplary embodiments.

Such an arrangement enables the switch contact to operate in a higher voltage power and the integrated DC soft turn-off module could undertake higher HVDC power since each soft turn-off circuit shares voltage.

Therefore, the DC soft turn-off module according to the present invention facilitates the manufacture process, since it incorporates cheap devices as well as a simple circuit architecture. Meanwhile, the invention presents an excellent practical performance in extinguishing the arc rapidly and efficiently.

### BRIEF DESCRIPTION OF THE DRAWINGS

FIG. 1 is a circuit diagram of a DC soft turn-off module according to a first exemplary embodiment of the invention.

FIG. 2 is a circuit diagram of a DC soft turn-off module according to a second exemplary embodiment of the invention.

FIG. 3 is a circuit diagram of a DC soft turn-off module according to a third exemplary embodiment of the invention.

FIG. 4 is a circuit diagram of a DC soft turn-off module according to a fourth exemplary embodiment of the invention.

### DETAILED DESCRIPTION OF THE EMBODIMENTS

Referring to FIG. 1, a DC soft turn-off module according to the invention comprises a switch contact K1, and a soft turn-off circuit connected in parallel onto the switch contact K1. The switch contact K1 comprises a first terminal (1) and a second terminal (2). The switch contact K1 is a metal contact of a switch. A terminal X1 is an anode of a HVDC power, and a terminal X2 is a cathode of the HVDC power. The first terminal (1) of the switch contact K1 connects to the anode X1 of the HVDC power, the second terminal (2) of the switch contact K1 connects to one end of an electrical load RL, and the other end of the load RL connects to the cathode X2 of the HVDC power. The switch contact K1 is opened or closed for controlling the current condition of the load RL.

The soft turn-off circuit is connected in parallel onto the first terminal (1) and second terminal (2) of the switch contact K1. The soft turn-off circuit comprises three branches connected each other in parallel.

The first branch comprises a thermistor RT1 and a first thyristor VT11 connected in series. One end of the thermistor RT1 connects to the first terminal (1) of the switch contact K1, the other end of the thermistor RT1 connects to an anode all of the first thyristor VT11, and a cathode b11 of the first thyristor VT11 connects to the second terminal (2) of the switch contact K1. The thermistor RT1 is chosen from a PTC device having a positive temperature coefficient, and the holding current Ih of the first thyristor VT11 is chosen to be greater than 10 mA.

The second branch comprises a capacitor C1 and a first resistor R11 connected in series and connected in parallel onto the first branch. One end of the capacitor C1 connects to the first terminal (1) of the switch contact K1, the other end of the capacitor C1 connects to one end of the first resistor R11, and the other end of the first resistor R11 connects to the second terminal (2) of the switch contact K1. A second thyristor VT21, along with a second resistor R21 and a third resistor R31 form a trigger branch, functioning as a trigger and providing trigger signal for the first thyristor VT11. An anode a21 of the second thyristor VT21 connects to a series connection (3) between the capacitor C1 and the first resistor R11, a control gate c21 of the second thyristor VT21 and the third resistor R31 in series connects to the series connection (3), a cathode b21 of the second thyristor VT21 connects to one end of the second resistor R21, the other end of the second resistor R21 connects to the second terminal (2) of the switch contact K1, and a series connection (4) between the cathode b21 of the second thyristor VT21 and the second resistor R21 connects to a control gate c11 of the first thyristor VT11.

The first thyristors VT11 and the second thyristor VT21 are silicon controlled rectifiers (SDR), which are kinds of high power semiconductor devices having three P-N connections between four layers, also known as a thyristor. The first thyristors VT11 and the second thyristor VT21 can be turned off under two conditions: the removal of the trigger signal on the control gate, and the current through the thyristor less than its holding current Ih.

The third branch comprises a varistor RV1 connected in parallel onto the first branch and the second branch. One end of the varistor RV1 connects to the first terminal (1) of the switch contact K1, the other end of the varistor RV1 connects to the second terminal (2) of the switch contact K1. The varistor is preferably a zinc oxide arrester. The third branch may be removed on the condition that a current to be cut off by the switch contact K1 and a voltage of the DC power are not too high.

The arc is extinguished by the following process.

1. While the switch contact K1 is closed, the load RL is operating normally, and the voltage on the capacitor C1 is zero, with no charges storage therein.

2. At the moment when the switch contact K1 is switched off, the voltage on both terminals of the switch contact K1 is zero, because the voltage of the C1 cannot change immediately. Due to the transition process of the circuit, the high current on the load RL will not disappear immediately but remains for a period of time. At this point, the HVDC power charges the capacitor C1 through the load RL and the first resistor R11, which in return alleviates the climbing speed of the voltage on the two terminals of the switch contact K1.

3. At the moment when the switch contact K1 is off, a pulse voltage is generated on the first resistor R11, and is applied on the control gate of the first thyristor VT11 through the second thyristor VT21, so as to trigger the conduction of the first thyristor VT11.

4. After the capacitor C1 is fully charged, the voltage on C1 is as high as the voltage of the HVDC power and the voltage divided on the first resistor R11 drops to zero. Since the current through VT21 is less than its holding current Ih21, and the voltage on its control gate c21 drops to zero as well, the VT21 is therefore turned off. The turn-off of the VT21 causes the control gate c11 voltage as a trigger signal of the VT11 to be zero. The removal of the trigger signal on the control gate c11 of the VT11 meets one of the requirements for the turn-off of the VT11.

5. The conducting first thyristor VT11 directs the high current on the load RL to the branch comprising the thermistor RT1 and the first thyristor VT11 connected in series. At first point, since the thermistor RT1 is in cold state and therefore has a lower resistance, the current on the branch comprising the thermistor RT1 and the first thyristor VT11 connected in series is high. The energy released by switching off the circuit is consumed rapidly by the thermistor RT1, which facilitates the shut-down of the switch contact K1. As the conduction of the thermistor RT1 warms up the thermistor RT1, its resistance value continues to increase, since its PTC material has a positive temperature coefficient. Accordingly, the current through the thermistor RT1 continues to decrease, which is termed as “soft turn-off”. There is no arc, or extremely few arc to be generated therefore the safe cut-off of the switch contact K1 is guaranteed. When the temperature becomes greater than the switch temperature, i.e. the Curie Temperature, of the PTC material, the resistance value will be multiplied as much as 10¹⁰ Ohm in theory, or as much as 10⁶ Ohm in practice. The current through the first branch comprising the thermistor RT1 and the first thyristor VT11 finally decreases to less than 10 mA. The holding current Ih11 of the first thyristor VT11 is chosen from a value larger than 10 mA and the current through the first thyristor VT11 is less than the holding current 10 mA, which meets the second requirement for the turn-off of the thyristor. As the first thyristor VT11 may not remain conduction, it is automatically turned off, so as to finish the turn-off of the switch contact K1. The thermistor RT1 is cooled down to original state.

6. When the switch is turned on again, the switch contact K1 is closed, then the capacitor C1 charges the first resistor R11 and the voltage on the capacitor C1 drops to zero, prepared for the next switch-off.

7. With the third branch comprising the varistor RV1, the over-voltage generated throughout the switch-off transition may be absorbed. While the current to be cut off by the switch contact K1 is not too high, e.g. less than 20 amp, and the voltage of the DC power is not too high as well, e.g. less than 2000V, the third branch is not necessary and may be removed.

The exemplary embodiment according the present invention applies a “non-electrical-isolation soft turn-off” mechanism, which has a simple circuit architecture while is able to efficiently extinguish the arc generated throughout the switch turn-off.

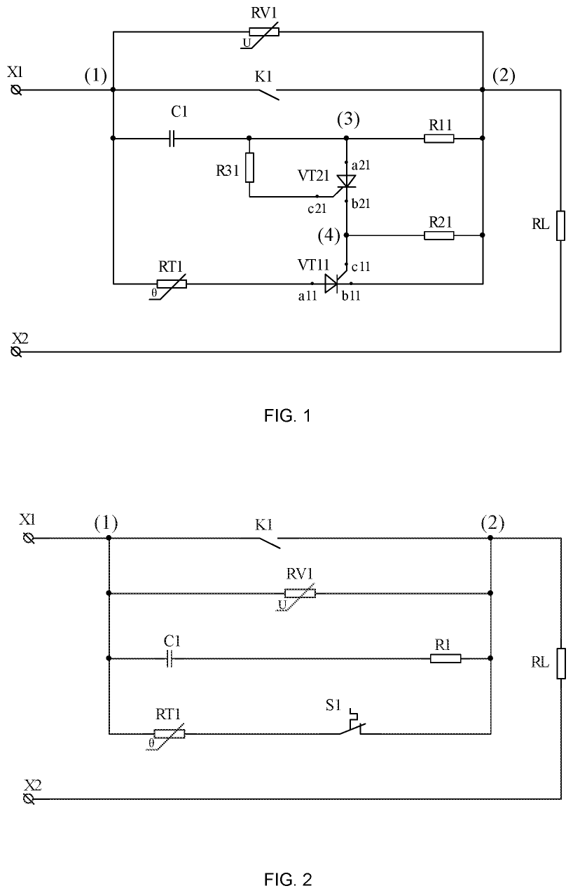

Referring to FIG. 2, in the second exemplary embodiment, the DC soft turn-off module according to the present invention comprises a switch contact K1 and a soft turn-off circuit connected in parallel onto the switch contact K1. The switch contact K1 comprises a first terminal (1) and a second terminal (2). Different from the first exemplary embodiment, a temperature-controlled switch S1 is provided in place of the first thyristor VT11, further simplifying the whole circuit architecture due to the omission of the trigger branch circuit including the second thyristor VT21.

The temperature-controlled switch S1 is a temperature controller including a pair of metal sheets as its temperature sensing element. In normal operation, the pair of metal sheets are under free state, i.e. the switch contact is in a closed or an open status. When an operating temperature is reached, the pair of metal sheets are heated up to such a level that a stress is emerged therebetween, which rapidly making the pair of metal sheets opened or closed, so as to break or connect the circuit. Accordingly the temperature control is realized. When cooled down to its reset temperature, the switch S1 could be closed or opened, automatically or manually, to regain its normal operation status.

There are a variety of the said temperature-controlled switches. Its contact may be a closed type in which it is closed under the action temperature and opened when reaching the action temperature, or may be an opened type in which it is opened under the action temperature and closed when reaching the action temperature. Its contact may also be an automatic-reset type in which it is automatically reset when cooling down to the reset temperature, or a manual-reset type in which it is manually reset when cooling down to the reset temperature. Due to the development of the manufacture process, the operating temperature can be defined by the customer and can be defined in a sufficient precision, preferably an absolute error of ±2° C., or typically an absolute error of ±5° C., both of which meet the requirement of the present invention. In this exemplary embodiment a closed and manual-reset type contact is applied.

The above described DC soft turn-off module is used for a HVDC power, wherein the terminal X1 is the anode and the terminal X2 is the cathode. The soft turn-off circuit connected in parallel onto the first terminal (1) and the second terminal (2) of the switch contact K1 and comprises three branches connected each other in parallel.

The first branch comprises a thermistor RT1 and a temperature-controlled switch S1 connected in series, wherein one end of the thermistor RT1 connects to the first terminal (1) of the switch contact K1, the other end of the thermistor RT1 connects to one end of the temperature-controlled switch S1, and the other end of the temperature-controlled switch S1 connects the second terminal (2) of the switch contact K1.

The second branch connected in parallel onto the first branch comprises a capacitor C1 and a first resistor R11 connected in series. One end of the capacitor C1 connects to the first terminal (1) of the switch contact K1, the other end of the capacitor C1 connects to one end of the first resistor R11, and the other end of the first resistor R11 connects to the second terminal (2) of the switch contact K1. The second branch is applied as an snubber circuit, allowing the switch contact K1 opened substantially under a state of zero voltage.

The third branch comprises a varistor RV1 connected in parallel onto the first branch and the second branch. One end of the varistor RV1 connects the first terminal (1) of the switch contact K1, the other end of the varistor RV1 connects to the second terminal (2) of the switch contact K1. The varistor RV1 is preferably a zinc oxide arrester. Likewise, the third branch may be removed while the current to be cut off by the switch contact K1, as well as the voltage of the DC power, are not too high.

Similar with the first exemplary embodiment, the arc is extinguished as following principles. When the switch contact K1 is switched off, since the initial state of the temperature-controlled switch S1 is closed, the high current on the load RL is directed to the branch comprising the thermistor RT1 and the temperature controlled switch S1 connected in series. The conducting thermistor RT1 warms up and radiates its heat to the temperature-controlled switch S1. Till the temperature-controlled switch reaches its operating temperature, the switch contact of the temperature S1 changes from a closed state into an opened state, thus breaking the branch as well as finishing the switch-off. Since the circuit break, the thermistor RT1 and the temperature-controlled switch S1 cools down, so that the thermistor RT1 restores its low resistance, and the temperature-controlled switch S1 may be reset by a mechanical toggle when the switch is switched on, as prepared for the next switch-off.

The exemplary embodiment applies an electrical-isolation soft turn-off mechanism, which has a simple circuit architecture while is able to extinguish the arc generated throughout the switch turn-off efficiently.

As described above, the DC soft turn-off modules according to the two exemplary embodiments of the invention share a common characteristic: a plurality of branches is connected in parallel onto a contact of a switch, so as to function as an entire whole as a DC soft turn-off module.

In the first exemplary embodiment, there are three branches being connected in parallel to the switch contact K1. The first branch comprises the thermistor RT1 and the first thyristor VT11 connected in series. The second branch comprises the capacitor C1 and the first resistor R11 connected in series, wherein the second thyristor VT21 and the resistors R21 and R31 connected in series are provided in parallel to the first resistor R11. The series connection (4) of the second thyristor VT21 and the second resistor R21 is connected to the control gate of the first thyristor VT11. The third branch comprises a single varistor RV1.

In the second exemplary embodiment, there are three branches being connected in parallel to the switch contact K1. The first branch comprises the thermistor RT1 and the temperature-controlled switch S1 connected in series. The second branch comprises the capacitor C1 and the first resistor R11 connected in series. The third branch comprises a single varistor RV1, which could be cancelled on the condition that a current to be cut off by the switch contact K1 and a voltage of the DC power are not too high. In a preferred embodiment a closed and manual-reset type contact of the switch S1 is chosen.

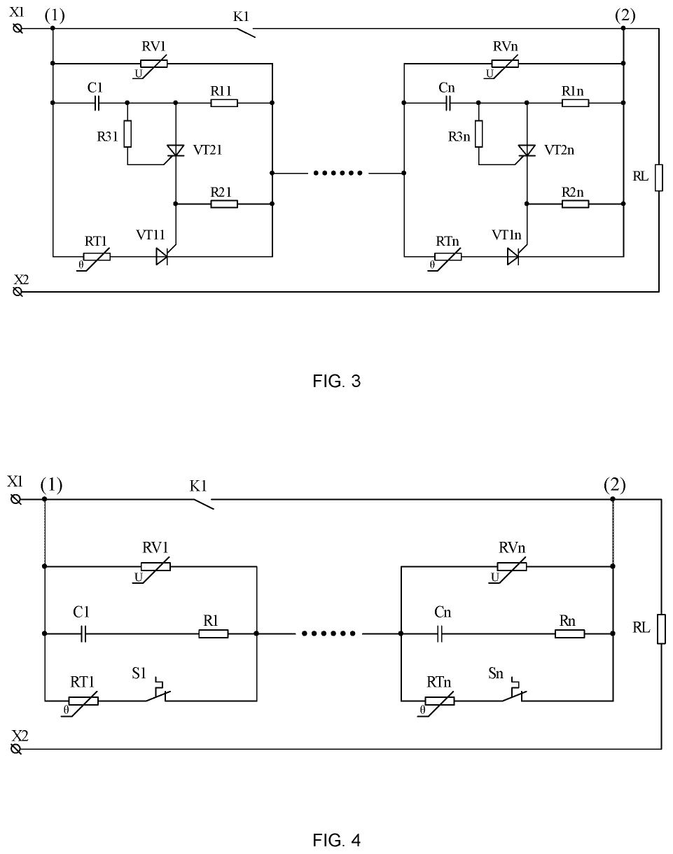

FIG. 3 and FIG. 4 respectively illustrate two extended exemplary embodiments of the DC soft turn-off module on the basis of the first and the second exemplary embodiment of the invention. Referring to FIG. 3, the DC soft turn-off module according to the third exemplary embodiment comprises a switch contact K1 and a plurality of soft turn-off circuits connected in series which are then connected in parallel onto a first terminal (1) and a second terminal (2) of the switch contact K1. The three branches of each soft turn-off circuit are connected in parallel to each other.

Such an arrangement is provided for enabling the switch contact K1 to operate in a higher voltage power. Each soft turn-off circuit comprises three branches as described in the first exemplary embodiment.

Referring to FIG. 4, the DC soft turn-off module according to the forth exemplary embodiment comprises a switch contact K1 and a plurality of soft turn-off circuits connected in series which are connected on the first terminal (1) and second terminal (2) of the switch contact K1. Each soft turn-off circuit comprises two branches as described in the second exemplary embodiment. Therefore, the integrated DC soft turn-off module could undertake higher HVDC power since each soft turn-off circuit shares voltage.

In the present industry, the electronic components used in the invention, such as the varistor RV, the thyristor VT, the capacitor C and the resistors, typically operate under a voltage of approximately 1000V. Those components with operating voltage higher than 1000V are expensive and meanwhile not easily purchased. While the plurality of circuit branches in series are utilized, the voltage each branch needs to bear is reduced, therefore the tolerance voltage of each component is also reduced. For example, if the switch contact K1 needs to break a 10 KV voltage, connecting in series 10 soft turn-off circuits each having an operating voltage of 1 KV, may achieve the required function of the switch contact K1. The specific amount of needed soft turn-off circuit can be calculated in the same manner.

The DC soft turn-off module according to the present invention facilitates the manufacturing process, since it incorporates cheap components and devices as well as a simple circuit architecture. Meanwhile, the invention presents an excellent practical performance in extinguishing the arc rapidly and efficiently. The DC soft turn-off of this invention, in combination with a housing and a mechanic toggle means, could form a switch product.

What is claimed is:

1. A DC soft turn-off module comprising a switch contact and at least one soft turn-off circuit connected in series and connected in parallel onto the switch contact, wherein each soft turn-off circuit comprises a first branch and a second branch connected in parallel, wherein:
the first branch comprises a thermistor and a first thyristor connected in series, wherein the thermistor is a PTC device having a positive temperature coefficient, and the holding current Ih of the first thyristor is greater than 10 mA,
the second branch comprises a capacitor and a first resistor connected in series, and
a second thyristor, a second resistor and a third resistor form a trigger branch for the first thyristor, wherein an anode of the second thyristor connects to a series connection between the capacitor and the first resistor, a control gate of the second thyristor and the third resistor in series connects to the series connection, a cathode of the second thyristor connects to one end of the second resistor, and the other end of the second resistor connects to the second terminal of the switch contact, and a series connection between the cathode of the second thyristor and the second resistor connects to a control gate of the first thyristor.

2. The DC soft turn-off module according to claim 1, wherein each soft turn-off circuit further comprises a third branch comprising a varistor connected in parallel onto the first branch and the second branch.

3. A DC soft turn-off module comprising a switch contact and at least one soft turn-off circuit connected in series and connected in parallel onto the switch contact, wherein each soft turn-off circuit comprises a first branch and a second branch connected in parallel, wherein:
the first branch comprises a thermistor and a temperature-controlled switch connected in series; and
the second branch comprises a capacitor and a resistor connected in series.

4. The DC soft turn-off module according to claim 3, wherein each soft turn-off circuit further comprises a third branch comprising a varistor connected in parallel onto the first branch and the second branch.
